(19) United States
(12) Patent Application Publication
(10) Pub. No.: US 2006/0151363 A1
(43) Pub. Date: Jul. 13, 2006

(54) Modular disc filter with integrated and automated self-flushing operator

(76) Inventor: Claudiu-Ioan Ratiu, Cluj-Napoca (RO)

Correspondence Address: NEIL K. NYDEGGER;NYDEGGER & ASSOCIATES, 348 Olive Street, San Diego, CA, 92103, US

(21) Appl. No.: 11/030,931

(22) Filed: Jan. 7, 2005

(51) Int. Cl. B01D 35/14

(52) U.S. Cl. 210/90; 210/106; 210/332; 210/420; 210/409

(57) ABSTRACT

A filter module for a filter battery includes an outer wall that surrounds a chamber having inflow and outflow ends. An inner wall divides the chamber into a plurality of compartments including an inflow compartment, outflow compartment, bi-directional compartment and drain compartment. Each compartment extends from the inflow end to the outflow end of the chamber. First and second holes are formed in the outer wall providing access to the bi-directional and outflow compartments, respectively. For each module, a filter is positioned outside the chamber and along a flow path between the bi-directional compartment and the outflow compartment. A valve directs flow within the module and switches the module between modes. In fluid filtering mode, fluid passes sequentially through the inflow compartment, bi-directional compartment, filter and then the outflow compartment. In a filter cleaning mode, fluid passes sequentially through the outflow compartment, filter, bi-directional compartment, and then the drain compartment.

### FIELD OF THE INVENTION

The present invention pertains generally to systems and methods for filtering a fluid flow. More particularly, the present invention pertains to fluid flow filters that are self-cleaning. The present invention is particularly, but not exclusively, useful as a modular, filtration system.

### BACKGROUND OF THE INVENTION

Fluid filtration can be used to separate liquids and suspended solids, either for recovery of the solids, classification of the liquid, or both. Typical filters that are employed for these applications can include, but are not necessarily limited to, porous cloths, filter papers, membranes and granular beds.

In general, the filter type and capacity are selected after estimating the maximum fluid flow rate, the amount and nature of the suspended solids in the liquid, and the desired purity of the filtrate. These design parameters, however, may often change over the service life of a particular installation. By way of example, for a pre-existing irrigation system, it may be desirable to increase water flow or water purity over what was initially prescribed at the time of installation. Accordingly, highly adaptable, quickly expandable filtration systems are often sought.

Heretofore, standard filtration systems have typically been initially constructed, and updated, using individualized components to include a filter, connecting pipes, fittings, couplers, an air valve and a flushing valve body. These components are then assembled in a labor-intensive process to establish a relatively complex self-cleaning filter unit having the appropriate size and capability. Accordingly, there is a desire in the pertinent art for simplification.

In light of the above, it is an object of the present invention to provide filter modules that can be easily combined to create a relatively small, compact filter battery having a pre-selected filtering capacity. It is another object of the present invention to provide a filter module that is self cleaning in response to a control input (e.g. a hydraulic control input). It is yet another object of the present invention to provide a filter module for a filter battery that is made of materials that are compatible for a specific application (i.e. food industry, chemical industry, irrigation, etc.). Yet another object of the present invention is to provide a filter module, filter bank and methods for filtering a fluid which are easy to use, relatively simple to implement, and comparatively cost effective.

### SUMMARY OF THE INVENTION

The present invention is directed to filter batteries, interconnectable modules for a filter battery and, in general, methods for using a filter battery to filter a fluid flow. For the present invention, a filter battery module includes an outer wall that surrounds a chamber. The chamber, for the present invention, extends from an inflow end to an outflow end. Within this chamber, an inner wall divides the chamber into a plurality of compartments. These compartments include an inflow compartment, an outflow compartment, a bi-directional compartment and, in some cases, a drain compartment. For each module, the compartments each extend from the inflow end to the outflow end of the chamber. First and second holes are formed in the outer wall to provide access to the bi-directional and outflow compartments, respectively.

With the above-described cooperation of structure, a filter can be positioned outside the chamber and along a flow path between the bi-directional compartment and the outflow compartment. More specifically, during a fluid filtering mode, the arrangement establishes a fluid path wherein contaminated fluid entering an inlet to the module is forced to pass sequentially through the inflow compartment, bi-directional compartment, filter and then the outflow compartment. From the outflow compartment, filtered fluid exits the module through an outlet. From the outlet, the filtered fluid either enters the outflow compartment of another module or exits the filter battery.

In addition to the fluid filtering mode, the filter module can also operate in a filter cleaning mode. In greater structural detail, a valve, which is typically hydraulically activated and has a moveable piston is provided to switch the filter module between the fluid filtering mode and the filter cleaning mode. For cooperation with the valve's piston, a first passageway is formed in the inner wall between the inflow compartment and the bi-directional compartment. In addition, a second passageway is formed in the inner wall between the bi-directional compartment and the drain compartment. With these passageways, the valve can be activated, for example, by an external hydraulic drive, to selectively move the piston. Specifically, the piston can be moved from a first, fluid filtering position in which the piston closes the second passageway (leaving the first passageway open) and a second, filter cleaning position in which the piston closes the first passageway (leaving the second passageway open). With the piston in the filter cleaning position, the filter module defines a fluid path in which fluid under pressure in the outflow compartment is forced to pass sequentially from the outflow compartment, through the filter and into the bi-directional compartment. From the bi-directional compartment, the fluid then flows through the second passageway to the drain compartment.

In a particular embodiment of the filter module, the filter includes a cover and a plurality of filter elements that are formed as annular-shaped disks and are stacked together to surround a first, generally cylindrically shaped volume. Specifically, the cover is somewhat cylindrically shaped and has an open end and a closed end. In the construction of the filter, the stack of filter elements is positioned in the cover to define a second volume in the space between the cover and the filter elements of the filter. When this embodiment of the filter module is configured in the fluid filtering mode, fluid flows through the first fluid passageway from the bi-directional compartment, through the first hole in the outer wall and into the second volume between the cover and filter. Once in the second volume, the fluid flows from there through the filter elements and into the first volume. From the first volume, fluid flows through the second hole formed in the outer wall and into the outflow compartment.

For one embodiment of the filter module, a plurality of elongated wash tubes are provided. Each wash tube is formed with a respective lumen and a plurality of nozzles that extend through the tube from the lumen to the outer surface of the tube. With this structure, each wash tube is positioned within the annular shaped filter disks (i.e. in the first volume). For each wash tube, the second hole in the outer wall establishes fluid communication between the wash tube's lumen and the outflow compartment. A spring loaded valve is operationally positioned to selectively open and shut the second hole in the outer wall. The spring holds the valve shut during filter cleaning to ensure that fluid from the outflow compartment only reaches the space within the annular shaped filter disks (i.e. the first volume) after passing through the wash tubes. On the other hand, when the module is in fluid filtering mode, the spring loaded valve opens in response to a pressure differential that develops between the first volume and the outflow compartment. With the spring loaded valve open, filtered fluid flows into the outflow compartment and then exits the filter module.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a filter battery made up of two filter modules;

FIG. 1A is a perspective view of an input coupling having a threaded connector;

FIG. 1B is a perspective view of an input coupling having a Victaulic connector;

FIG. 2 is a front perspective view of a filter module;

FIG. 3 is a rear, perspective view of the filter module of FIG. 2, shown with a peripheral component exploded in a perspective view;

FIG. 4 is a view of a filter module in partial cross-section as seen along line 4-4 in FIG. 2, shown with the hydraulic valve in the fluid filtering position;

FIG. 5 is a view of a filter module in partial cross-section as FIG. 4, shown with the hydraulic valve in the filter cleaning position; and

FIG. 6 is an enlarged view of the top portion of the filter module as shown in FIG. 5.

### DESCRIPTION OF THE PREFERRED EMBODIMENTS

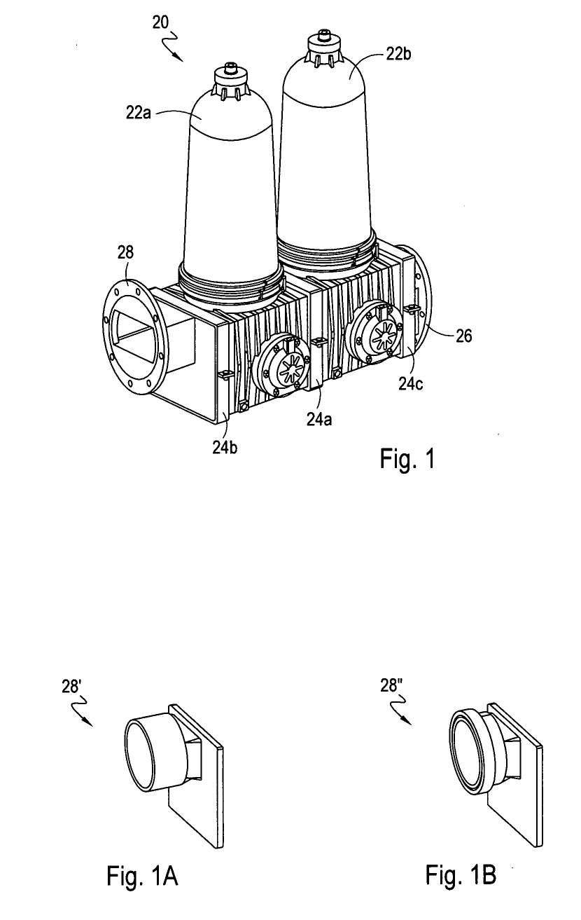

Referring initially to FIG. 1, a filter battery for filtering suspended solids from a fluid flow is shown and generally designated 20. As shown in FIG. 1, the filter battery 20 is made up of two modules 22a,b that are attached together by a band 24a. For the filter battery 20, contaminated fluid (e.g. water) flows into the battery 20 through an input coupling 26, is filtered by one of the modules 22a,b and then flows out of the filter battery 20 through output coupling 28. For the embodiment shown in FIG. 1, the output coupling 28 is formed with a flange coupling. Alternatively, FIG. 1A shows that an output coupling 28′ having a threaded connector can be used for the battery 20. As yet another alternative for use in the battery 20, an output coupling 28″ having a Victaulic connector is shown in FIG. 1B.

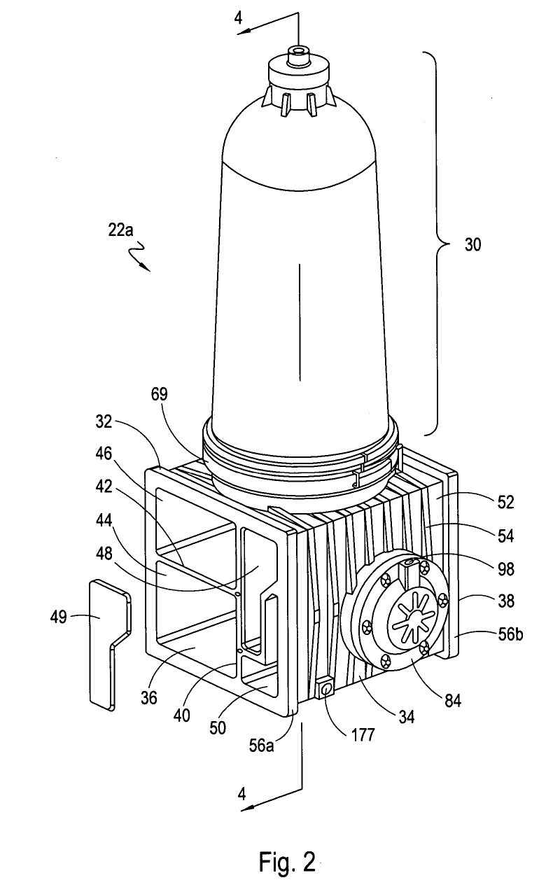

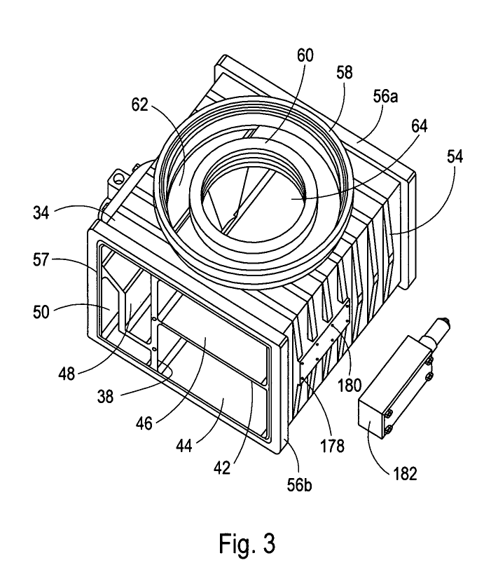

As best seen in FIG. 2, the filter module 22a includes a filtration assembly 30 and a controller 32. For the module 22a, the controller 32 includes a substantially rectangular outer wall 34 that surrounds and defines a substantially rectangular chamber 36. The chamber 36, in turn, extends from an inflow end 38 to an outflow end 40. Within this chamber 36, an inner wall 42 divides the chamber 36 into an inflow compartment 44, an outflow compartment 46, a bi-directional compartment 48 and a drain compartment 50. The bi-directional compartment 48 can be separated from the bi-directional compartment 48 of adjoining modules 22 by a partition 49, as shown. For each module 22 in the battery 20, the inflow compartment 44 is maintained in continuous fluid communication with the input coupling 26 and the outflow compartment 46 is maintained in continuous fluid communication with the output coupling 28. From FIGS. 2 and 3, it can be gathered that each compartment 44, 46, 48, 50 extends from the inflow end 38 to the outflow end 40 of the chamber 36. FIG. 2 also shows that the outer surface 52 of the outer wall 34 is formed with a plurality of ribs 54.

With cross-reference to FIGS. 1 and 2, it can be seen that the outer wall 34 is formed with a pair of rectangular flanges 56a,b at each end 38, 40 to allow the module 22a to be connected to other modules (e.g. module 22b), an input coupling 26 or an output coupling 28. For this purpose, bands 24a-c having a U-shaped cross section can be provided, as shown in FIG. 1. The face of each flange 56a,b is formed with a groove 57 (FIG. 3) to accommodate a gasket (not shown) to seal each module 22a,b into engagement with either another module 22a,b or a coupling 26, 28. Alternatively, for some embodiments, the modules 22a,b and couplings 26, 28 can be made of a thermoplastic polymer and thermo-welded together.

As best seen in FIG. 3, the controller 32 is formed with a pair of concentric rings 58, 60 which extend upwardly from outer wall 34 to mount the filtration assembly 30 (see FIG. 2) on the controller 32. FIG. 3 further shows that the outer wall 34 is formed with a first hole 62 that is positioned between the concentric rings 58, 60 and extends through the outer wall 34 and into the bi-directional compartment 48. In addition, as shown in FIG. 3, the outer wall 34 is formed with a second hole 64 that is positioned within the ring 60 and extends through the outer wall 34 and into the outflow compartment 46.

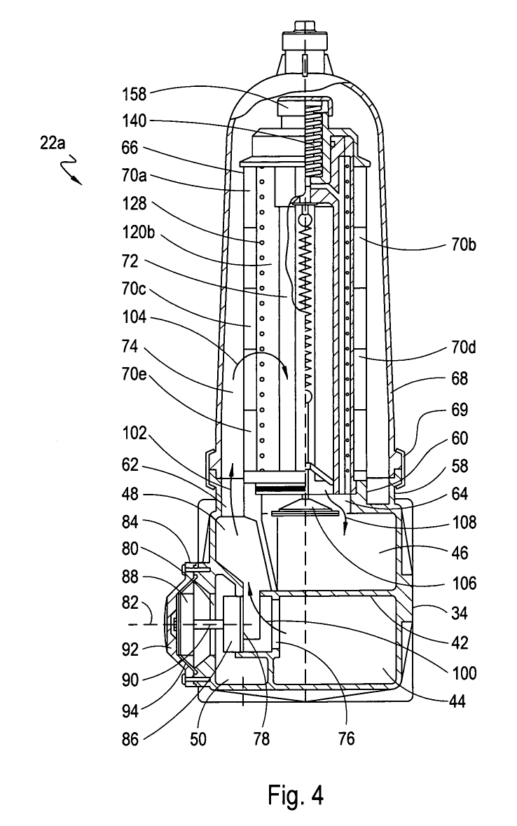

The rings 58, 60 and first and second holes 62, 64 can also be seen in FIG. 4. As shown there, the filtration assembly 30 (see FIG. 2) includes a generally cylindrically shaped filter 66 that is fixed on the inner ring 60 and a generally cylindrically shaped cover 68 that is mounted on the outer ring 58 by way of a band 69 having a U-shaped cross section. For the embodiment shown, the filter 66 includes a plurality of filter elements 70a-e that are formed as annular shaped disks and stacked together to surround a generally cylindrically shaped volume 72. As shown in FIG. 4, the multi-element filter 66 is positioned in the cover 68 to define a somewhat annular shaped volume 74 between the cover 68 and the filter 66.

FIG. 4 shows the interaction between the compartments 44, 46, 48, 50 in greater detail. Specifically, it can be seen that the inner wall 42 is formed with a circular passageway 76 that connects the inflow compartment 44 with the bi-directional compartment 48. It can be further seen that the inner wall 42 is formed with another circular passageway 78 that connects the bi-directional compartment 48 with the drain compartment 50. A third circular passageway 80 is formed in the outer wall 34 providing an access to the drain compartment 50. As shown, all three circular passageways 76, 78, 80 are aligned normal to a common axis 82 and are all centered on the common axis 82.

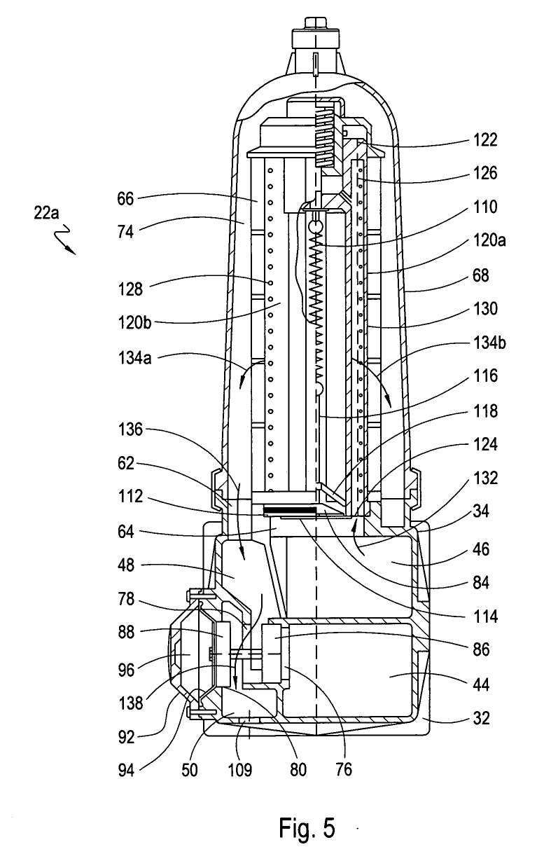

With cross-reference now to FIG. 2 and FIG. 4, it can be seen that the controller 32 of each module 22a,b includes a built-in, hydraulically activated valve 84 to switch the filter module 22a,b between a fluid filtering mode and a filter cleaning mode. In greater structural detail, the valve 84 includes a pair of moveable pistons 86, 88 that are spaced apart, connected by a rod 90, and positioned for movement along the axis 82. A dome shaped cap 92 is attached by threaded fasteners to the outer wall 34, as shown. Flexible membrane 94 is attached to and extends radially from piston 88 and is secured at its extremity between the cap 92 and outer wall 34, as shown in FIG. 4. With this cooperation of structure, as best seen in FIG. 5, a hydraulic chamber 96 is established between the cap 92 and the membrane 94. A port 98 (see FIG. 2) allows a hydraulic pressure to be input into the chamber 96 from an external hydraulic drive (not shown).

Movement of the valve 84 in response to a hydraulic drive input can best be appreciated by cross-reference to FIGS. 4 and 5. Specifically, FIG. 4 shows the valve 84 in the absence of a hydraulic input through port 98 (shown in FIG. 2). In this position, piston 86 blocks passageway 78 while passageways 76 and 80 remain open. With the valve 84 in the position shown in FIG. 4, the module 22a is in fluid filtering mode. In fluid filtering mode, fluid in the inflow compartment 44 is forced to flow through open passageway 76 and into the bi-directional compartment 48 (arrow 100). Next, arrow 102 shows that fluid flows from the bi-directional compartment 48 and into the annular volume 74 between the filter 66 and cover 68. Once in the annular volume 74, arrow 104 indicates that fluid flows through the filter 66 and into the cylindrical volume 72. Once the fluid is inside the cylindrical volume 72, a pressure differential between the volume 72 and outflow compartment 46 is developed that is sufficient to open spring loaded valve 106 and allow filtered fluid to flow in the direction of arrow 108 into the outflow compartment 46. Thus, in fluid filtering mode, contaminated fluid that enters inflow compartment 44 of the filter module 22a exits as filtered fluid through outflow compartment 46.

Referring now to FIG. 5, the valve 84 is shown in a position to configure the module 22a in filter cleaning mode. Specifically, FIG. 5 shows the module 22a after a hydraulic input from an external hydraulic drive (not shown) has been applied through port 98 (shown in FIG. 2). In greater detail, this hydraulic input is sufficient to overcome the fluid pressure in the inflow chamber 44, expand the hydraulic chamber 96, and translate the pistons 86, 88 along the axis 82 (FIG. 4) and toward the inflow compartment 44. FIG. 5 shows that the hydraulic input moves piston 86 into a position wherein the piston 86 covers the passageway 76. This effectively isolates the inflow compartment 44 from the remaining portions of the module 22a. Also shown in FIG. 5, the hydraulic input also moves piston 88 into a position wherein the piston 88 covers the passageway 80. It can also be seen that when the module 22a is in filter cleaning mode, passageway 78 remains open to provide fluid communication between the bi-directional compartment 48 and the drain compartment 50. An opening 109 formed in the outer wall 34 connects the drain compartment 50 to the atmosphere outside the module 22a and maintains the drain compartment 50, bi-directional compartment 48 and annular volume 74 at near ambient pressure when the module 22a is in filter cleaning mode.

With the inflow compartment 44 isolated from the remaining portions of the module 22a, fluid pressure in the outflow compartment 46 works in concert with spring 110 to close valve 84. In greater structural detail, valve 84 includes a generally annular shaped seat 112 and a stopper 114. The seat 112 is attached to the outer wall 34 of the controller 32 at the hole 64 for interaction with the stopper 114. Stopper 114 is connected to vertical rod 116, which in turn, is attached to spring 110 to bias stopper 114 upwardly. Guide 118 maintains the rod 116 and stopper 114 centered on a linear axis. For the module 22a, holes (not shown) are formed in the seat 112 to establish fluid communication (when the valve 84 is closed) between the four elongated wash tubes and the outflow compartment 46. (Note: only wash tubes 120a,b are shown and labeled in FIG. 5).

As best seen in FIG. 5, each wash tube 120a,b is formed with a closed top end 122, an open bottom end 124 and a lumen 126. As further shown, each wash tube 120a,b is formed with a plurality of spaced apart nozzles 128 that each extend from the lumen 126 to the outer surface 130 of the wash tube 120a,b. With this structure, each wash tube 120a,b is positioned inside and adjacent to the filter 66 in the cylindrical volume 72 with its lumen 126 in fluid communication with the outflow compartment 46, as shown.

With the piston 86 in the filter cleaning position as shown in FIG. 5, fluid flows sequentially along a fluid path that begins in the outflow compartment 46. From the outflow compartment 46, fluid flows through hole 64 in outer wall 34 and into the lumens 126 of the wash tubes 120a,b (arrow 132). Next, arrows 134a and 134b show that fluid flows from the lumens 126 of the wash tubes 120a,b, through the nozzles 128, through the filter 66 and into the annular volume 74. Once in the annular volume 74, arrow 136 indicates that fluid flows through the hole 62 and into the bi-directional compartment 48. From the bi-directional compartment 48, fluid flows through the open passageway 78 and into the drain compartment 50 (arrow 138) where it can exit the module 22a through the opening 109.

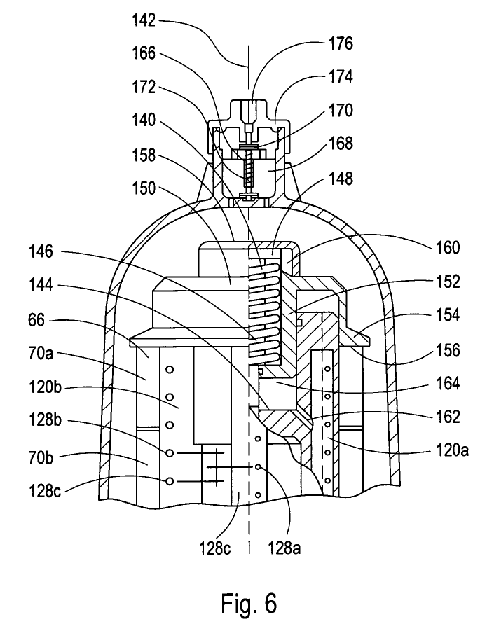

Referring now to FIG. 6, it can be seen that the nozzles 128 are vertically offset on adjacent wash tubes 120a-c to increase the efficiency of the filter cleaning mode. Specifically, dimension lines in FIG. 6 illustrate that nozzle 128a on wash tube 120c is vertically positioned midway between nozzles 128b and 128c on wash tube 120b. On the other hand, nozzles 128 on wash tube 120a are not vertically offset from the nozzles 128 on wash tube 120b.

Cross-referencing FIGS. 4 and 6, it can be seen that a spring 140 is provided to axially compress the filter elements 70a-c when the module 22a is in fluid filtering mode. In greater detail, FIG. 6 shows that the cylindrical filter 66 defines a vertical axis 142. Structurally, the wash tubes 120 are joined together by a bridge 144 which extends horizontally through the vertical axis 142. A rod 146 is mounted on the bridge 144 and extends vertically therefrom along the vertical axis 142 to a top end that is formed as an abutment 148. FIG. 6 also shows that the module 22a includes a compression member 150 having a cylindrical cup portion 152 that is centered on the vertical axis 142 and a cylindrical arm portion 154 that extends radially outward from the cup portion 152. The arm portion 154 is formed with a ring shaped, horizontal surface 156 for interaction with the filter 66, as shown. A nut 158 is provided for threaded engagement with rod 146. As shown, the nut 158 is formed with a collar 160 to prevent contaminates from reaching the spring 140. As best seen in FIG. 6, spring 140 expands between the abutment 148 and the cup portion 152 of the compression member 150. This expansion, in turn, biases the compression member 150 toward the bridge 144 and wash tubes 120. Under the influence of the spring 140, the compression member 150 compresses the filter elements 70a-e together when the module 22a is in the fluid filtering mode as shown in FIG. 4.

FIG. 6 shows the relationship between the spring 140, bridge 144 and compression member 150 when the module 22a is in filter cleaning mode. As seen there, a passageway 162 extends between the lumen 126 of the wash tube 120 and the volume 164 that is established between the bridge 144 and the lower surface of the cup portion 152 of the compression member 150. Typically, four such passageways 162 are provided, one for each wash tube 120. With this cooperation of structure, fluid in the wash tube 120 enters the volume 164 during filter cleaning and pushes the compression member 150 upward against the force of the spring 140. As best seen in FIG. 6, this hydraulic action on the compression member 150 decompresses the filter 66, freeing the filter elements 70 to rotate during filter cleaning. Rotation of the filter cleaning elements 70 increases filter cleaning efficiency.

FIG. 6 also illustrates that the module 22a includes an air release valve 166 that is incorporated into the module 22a at the top of the cover 68. Structurally, the air release valve 166 includes a floater 168, closing flap 170 and spring 172 that are disposed in a cylindrical cavity that is formed in the cover 68. Cap 174 is provided having a threaded port 176 to allow capture of fluid that inadvertently leaves the air release valve 166. If desired, a collecting tube (not shown) can be used to connect the threaded port 176 to threaded port 177 (see FIG. 2) to route fluid from the air release valve 166 to the drain compartment 50.

Referring back to FIG. 3, it can be seen that the outer wall 34 is formed with an access port 178 in fluid communication with the inflow compartment 44 and an access port 180 in fluid communication with the outflow compartment 46. These ports 178, 180 can be used to place a control element 182 in fluid communication with the inflow compartment 44, outflow compartment 46, or both. Examples of control elements include, but are not limited to a differential pressure transducer, a control filter and one or more pressure gauges.

It is to be appreciated that the modular and flexible concept shown herein with regard to a filter module can be extended to other devices, such as pressure valves, directional valves, injection dosage and mixing devices, etc. Specifically, the other devices can be built in the modular form, similar to the filter module described above. Moreover, by coupling these modular apparatuses, a variety of application circuits can be assembled.

While the particular Modular Disc Filter With Integrated and Automated Self-Flushing Operator and corresponding methods of use as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A module for a filter battery, said module comprising:
an outer wall at least partially surrounding a chamber, said chamber having an inflow end and an outflow end;
an inner wall dividing said chamber into a plurality of compartments including an inflow compartment, an outflow compartment, a bi-directional compartment and a drain compartment, with each compartment extending between said inflow end to said outflow end of said chamber;
a filter positioned along a flow path between said bi-directional compartment and said outflow compartment; and
a valve at least partially disposed in said chamber, said valve being moveable between a first, filtering valve position in which fluid flows sequentially through said inflow compartment, said bi-directional compartment, said filter and said outflow compartment, and a second, filter cleaning valve position in which fluid flows sequentially through said outflow compartment, said filter, said bi-directional compartment and said drain compartment.

2. A module as recited in claim 1 wherein said inner wall is formed with a passageway between said inflow compartment and said bi-directional compartment and said valve comprises a piston which blocks said passageway in said second, filter cleaning valve position.

3. A module as recited in claim 2 wherein said passageway is a first passageway and said inner wall is formed with a second passageway between said drain compartment and said bi-directional compartment and wherein said piston blocks said second passageway in said first, filtering valve position.

4. A module as recited in claim 1 wherein said filter comprises a plurality of disk shaped filter elements.

5. A module as recited in claim 4 further comprising a spring for creating a biasing force to bias said filter elements into a contiguous filter and a means for overcoming at least a portion of said biasing force to release said filter elements, said means operable when said valve is in said second filter cleaning valve position.

6. A module as recited in claim 5 wherein said overcoming means comprises a compressing member, said compressing member in contact with a fluid stream from said outflow compartment to compress said spring and release said filter elements.

7. A module as recited in claim 1 wherein said valve is reconfigurable into said second filter cleaning valve position in response to an input hydraulic pressure.

8. A module as recited in claim 1 wherein said module further comprises a cover, said filter is shaped to surround a first volume, said filter is positioned in said cover to define a second volume therebetween, said outer wall is formed with a first hole to establish fluid communication between said bi-directional compartment and said second volume and is formed with a second hole to establish fluid communication between said outflow compartment and said first volume.

9. A module as recited in claim 8 further comprising a plurality of elongated wash tubes for cleaning said filter, each wash tube formed with a respective lumen and a plurality of nozzles, with each wash tube positioned in said first volume with its respective lumen in fluid communication with said outflow compartment.

10. A module as recited in claim 8 wherein said valve is a first valve and wherein said module further comprises a second valve configured to close said second hole to prevent fluid flow from said outflow compartment into said first volume when said first valve is in said second filter cleaning valve position, and open said second hole to allow fluid flow from said first volume into said outflow compartment when said first valve is in said first filtering valve position.

11. A module as recited in claim 8 wherein said cover is formed with an air release valve.

12. A module as recited in claim 8 wherein said outer wall is formed with a first access port in fluid communication with said inflow compartment and a second access port in fluid communication with said outflow compartment, and wherein said module comprises a control element in fluid communication with said first and second access ports, said control element selected from the group of control elements consisting of a differential pressure transducer, a control filter and a plurality of pressure gauges.

13. A filter battery comprising:
a first filter module and a second filter module, each module having:
an outer wall at least partially surrounding a chamber, said chamber having an inflow end and an outflow end;
an inner wall dividing at least a portion of said chamber into a plurality of compartments including an inflow compartment, an outflow compartment and a bi-directional compartment, with each compartment extending from said inflow end to said outflow end of said chamber;
a filter positioned along a flow path between said bi-directional compartment and said outflow compartment;
a valve being reconfigurable between a first, filtering valve position and a second, filter cleaning valve position; and
a means for attaching said outflow end of said first module with said inflow end of said second module.

14. A filter battery as recited in claim 13 further comprising an end cap for attachment to said first module at said inflow end, said end cap formed with a connector for establishing fluid communication between said inflow compartment of said first module and a supply line.

15. A filter battery as recited in claim 14 wherein said connector is selected from the group of connectors consisting of a threaded connector, a Victaulic connector and a flanged connector.

16. A filter battery as recited in claim 13 wherein said outer wall and said inner wall of each module are made of a thermoplastic material and said outflow end of said first module is thermo-welded to said inflow end of said second module.

17. A filter battery as recited in claim 13 wherein each said module is formed with a first attachment flange at said inflow end and a second attachment flange at said outflow end and said attaching means comprises a strap having a U-shaped section for holding said first attachment flange of said second module against the second attachment flange of said first module.

18. A self-cleaning method of fluid filtration, said method comprising the steps of:
providing an outer wall at least partially surrounding a chamber, said chamber having an inflow end and an outflow end;
disposing an inner wall in said chamber to divide said chamber into a plurality of compartments including an inflow compartment, an outflow compartment, a bi-directional compartment and a drain compartment, with each compartment extending from said inflow end to said outflow end of said chamber;
positioning a filter along a flow path between said bi-directional compartment and said outflow compartment;
configuring a valve in a first, filtering valve position to open a passageway between said inflow compartment and said bi-directional compartment to cause fluid to flow sequentially through said inflow compartment, said bi-directional compartment, said filter and said outflow compartment; and thereafter
reconfiguring said valve in a second, filter cleaning valve position to block said passageway and cause fluid to flow sequentially through said outflow compartment, said filter, said bi-directional compartment and said drain compartment.

19. A method as recited in claim 18 wherein said filter comprises a plurality of disk shaped filter elements.

20. A method as recited in claim 18 wherein said reconfiguring step is accomplished using hydraulic pressure.
